(19) United States
(12) Patent Application Publication
(10) Pub. No.: US 2007/0276817 A1
(43) Pub. Date: Nov. 29, 2007

(54) Open System For Dynamically Generating A Network Of Contacts

(76) Inventors: Arnaud Massonnie, Paris (FR); Mats Carduner, Paris (FR)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/791,869

(22) PCT Filed: Nov. 30, 2004
(86) PCT No.: PCT/EP04/14808

§ 371 Date: Jul. 25, 2007

(51) Int. Cl. G06F 7/00

(52) U.S. Cl. 707/3; 707/103 R

(57) ABSTRACT

An open system for dynamically generating a network of contacts, wherein the network is implemented as levels in a tree that is propagated incrementally as a function of each given search from a user of a level “zero” to one or more final entities or “leaves” unknown to the user and satisfying search criteria, propagation taking place via entities of a level “1” forming a first network of acquaintances that are known directly and/or indirectly to the user, and via one or more intermediary entities of levels “n”, unknown to the user and each having a respective network of acquaintances formed by contacts with entities of levels “n+1”, the system including a filter which is run at each incremental level by removing duplication of contacts with entities so that each entity of level “n+1” in the chain refers to a unique entity of level “n” forming a linear reverse propagation.

### RELATED APPLICATION

This is a §371 of International Application No. PCT/EP2004/014808, with an international filing date of Nov. 30, 2004 (WO 2006/058558 A1, published Jun. 8, 2006).

### TECHNICAL FIELD

This disclosure relates to an open system for dynamically generating a network of contacts to normalize and qualify interpersonal co-option streams.

### BACKGROUND

Hereafter the words “search”, “need”, or more generally “use” should be understood as synonyms.

Several methods concerning networking issues are known. They are directed to a networking database having a plurality of records corresponding to individuals, more particularly, to a networking database in which the records of registered individuals are linked by defined relationships to the records of one or more other individuals.

The concept of networking, that is, expanding one's acquaintance of other people for personal or professional advantage, still requires person-to-person contact. Yet, the advance of technology has made it easier, mainly thanks to the spread of the Internet, and the ease of communicating by e-mail.

According to U.S. Pat. No. 6,175,831, main issues are to find an accurate e-mail service, and to know the e-mail address of other individuals the user wishes to get in touch with. There is no exhaustive global directory, and although some online services offer to register one's profile in a web-based database in order to get an e-mail address and communicate with other registered members, the usefulness of such services is quite limited for the end user. For those systems, the database is only a way of generating money based on subscription cost or on advertising to the user.

Therefore, U.S. Pat. No. 6,175,831 provides a method of constructing a networking database, in which a plurality of individuals register and become respectively linked with one or more other registered individuals by defined relationships, so that all members can take advantage of the database of a predetermined network for personal and/or professional gain. Finally, it aims at virtually translating the relationships that exist between individuals to enable registered members to take advantage of their personal and professional acquaintances, by getting in touch with other registered members connected, at one or more removes, to someone they already know.

U.S. Pat. No. 6,175,831 provides a generic method of constructing a networking database, whereas WO 03/030051 focuses on the Human Resources field. That disclosure defines a web-based application which enables job opportunities to be broadcast over a networking database.

Each member declares a part within the community, which could be for instance a recruiter, a professional head-hunter, an individual head-hunter, or a job seeker. The member provides information regarding both professional and personal characteristics, and specifies how widely his offer is to be visible in his extended network. Hence, when a recruiter or a head-hunter decides to post a job through the application, all the job seekers and all the individual head-hunters—members who are not active job seekers, but are interested in receiving job ads in order to spread them to their acquaintances—who are linked closely enough to the originator, and with profiles corresponding to the profile being sought, receive the information that there is a new job opportunity that matches their criteria.

Contrary to U.S. Pat. No. 6,175,831, WO 03/030051 does not allow each member to search for information on just any field. Each member plays a specific role: some members can spread information (job ads), others can receive it and forward it, and yet others can receive it and apply for it.

Those prior approaches entail many limits and disadvantages as emphasized hereafter:
The uniqueness of the networking database: the networking database model, disclosed in those patents, results in a complex web of relationships between individuals, which is unique whatever the characteristics of the search might be.
The difficulty of traceability: within a database, the state of art reproduces all the plurality of relationships A between individuals X (see FIG. 1), the unit being specifically the individual. This leads to a polymorphic relational model, where the interleaved intermediate members make the hierarchical relationships much more complex. Every member is simultaneously a “godparent” at a level x to another member at a level y, and in the same chain, a “godchild” of that same member at another level z. This type of architecture does not facilitate traceability of the propagation of a search within a community because of the multiple solutions for the return route.

Although the systems of U.S. Pat. No. 6,175,831 and WO 03/030051 do not broadcast offers in the same way, they both make similar polymorphic linkage: in U.S. Pat. No. 6,175,831, the originator has to search and find in the network the accurate profiles he wants to get in touch with, and to contact them after a validation by each of the intermediate nodes, node after node; in WO 03/030051, the originator is not aware of the profiles who are in his extended network, he just has to specify how widely his offer is visible (e.g. visible out to his third degree contacts), and bet on the possible matching of this contacts:
The necessity of a critical mass: the value of the sites of networking—social as professional one—increases with the number of its members, search and spread only occurring among the registered members.
The lack of dynamic means for improving the relevance of the system: there are no feedback on the answer relevance and no statistics on the members' quality. Only U.S. Pat. No. 6,175,831 provides quality information as the possible endorsements that members can do about other members, but it is not traducing one's objective efficiency among the network. The originator does not have any information about each member unless his professional profile. No way to be aware of the effectiveness of the role assumed by each of them.
In U.S. Pat. No. 6,175,831, the originator makes many searches in the database to diagnose the profiles which seem to be relevant. Then, the originator contacts them in a sequential and one-way process, one after the other. Boring and expensive, this process of sourcing represents finally a quite limited gain of speed with regard to the traditional search of information or of assessment.
WO 03/030051 simultaneously searches to satisfy (in this case, a job offer) among the members of the database which are close enough to the originator of the search. The main filter is based on two chances: where the originator is located in the meshing, and which are his contacts connected to the first level, to the second, to the nth one. There is no logic of co-option, no filter in every stage of broadcasting, and thus no possible control of the relevance of the persons who are aware of the offer. All those who surround him may receive the offer at the same time, from the moment they have the minimal professional profile required. This lack of confidentiality may represent a risk of abundance of applications for the originator, and moreover of parasitic one. Finally, to post an offer on this system comes to post an offer on a private job board (Web site dedicated to job opportunities): broadcasting is fast, applications are numerous, but the relevance of these often risks being defective.

The methods outlined above can provide for speedy deployment, but do not ensure relevance.

The viral phenomenon facilitated by the Internet ensures exponential growth of their databases, and so gives to the originator a community of dozens, or hundreds or thousand of persons interested in being outlined and in receiving offers corresponding to their centers of interest, to their assessments. Nevertheless, those systems do not propose any selection in broadcasting: the only selection is that of the members of the community itself. The broadcast of a need stops at the community boundaries, relevance stops at the effectiveness of members making the preliminary choice to join the community. Therefore, the larger the community, the poorer its targeting.

### SUMMARY

We provide an open system for dynamically generating a network of contacts and including means for improving the relevance of the system in satisfying searches.

As such, the approach includes building a networking database which is “use-centric” instead of “user-centric”. It amounts to building as many distinct networking databases as there are expressed searches. Such a system allows only linear chains to be obtained when a reverse propagation is considered (see FIG. 2).

To obtain such a linear reverse propagation as defined hereafter, we provide a filter that runs at each incrementation level to remove any entity contact duplication so that each entity of level “n+1” in the chain refers to a unique entity of level “n”.

We further provide a system which automatically memorizes a history of each of the entities actions and their engendered effects, which makes statistics on them, and which uses the statistics to optimize the future propagations of searches.

We further provide a progress filter that acts after that an “n” level entity decided to forward the search to an “n+1” level entity, by deciding whether a search will be transmitted to the “n+1” level entity by the system or not, in relation to the history, the statistics, and the level of entities.

According to a first aspect we provide an open system for dynamically generating a network of contacts, characterized in that the network is implemented as levels in a tree that is propagated incrementally as a function of each given search from a user of a level “zero” to one or more final entities or “leaves” unknown to the user and satisfying search criteria, propagation taking place via entities of a level “1” forming a first network of acquaintances that are known directly and/or indirectly to the user, and via one or more intermediary entities of levels “n”, unknown to the user and each having a respective network of acquaintances formed by contacts with entities of levels “n+1”, the system including a filter which is run at each incremental level to linearize the reverse propagation of the network by removing any duplication of contacts with entities so that each entity in the chain refers to a unique antecedent.

We also for the first time provide statistical analyses about the qualification of members to optimize future propagations of searches.

The term “open system” should be understood as a system without predetermined limits by opposition to closed network system or private network system wherein an information can be spread only between the registered member known by the system: if the system is constituted of a hundred members, the system will allows the broadcast of the information only between these members.

The system allows an originator to define the first nodes (entities) of propagation chains, and to specify the expression of the search to provide, the following nodes are the objects of an electronic co-option by their antecedent in the chain until it ends in one or several propositions of answer to the search. The confidentiality and the traceability during the broadcasting are upstream insured; the propagation quality engendered by each of the nodes is downstream estimated, thanks to statistics on each entity's goal and recommendation from the member who sent the offer to the applicant. The propagation efficiency is also based on a committed propagation, each entity receiving the offer by a trusted contact on referrals.

### BRIEF DESCRIPTION OF THE DRAWINGS

Other aspects of the disclosure will become apparent from the following description by way of example only and with reference to the accompanying drawings which show respectively:

FIG. 1 is a schematic representation of a conventional network;

FIG. 2 is a schematic representation of a network generated with one of our systems;

FIG. 3 is a schematic block diagram of a system;

FIG. 4 is a conceptual model of data of a system;

FIG. 5 is a schematic logical diagram of the distribution of a search in a system;

FIG. 6 is a schematic logical diagram of the working of a filter;

FIG. 7 is a schematic logical diagram of the development of one means for improving the efficiency of the system, focused on the recommendation; and

FIG. 8 is a schematic logical diagram of the development of another means for improving the efficiency of the system, focused on the Call-back.

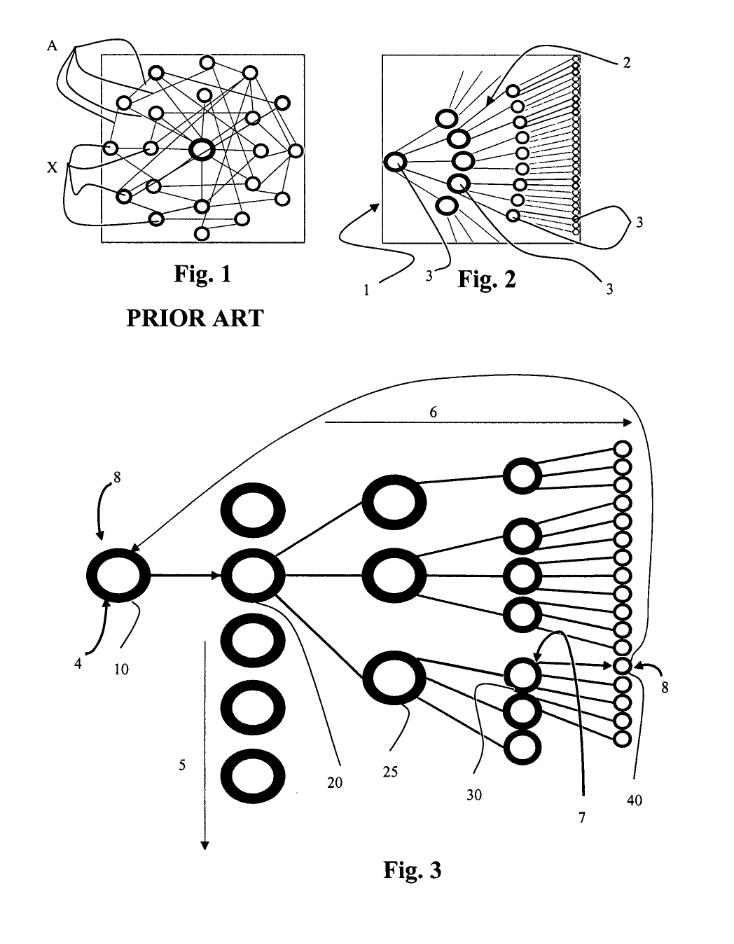

### DETAILED DESCRIPTION

In the following description, the terms shall be understood with regards to the hereafter definitions:
A “network” shall be understood as a network of contacts or as a network of network of contacts;
“unknown entity” shall be understood regarding the search: a user “A” can know physically an entity “B” without having identified it as able to satisfy the search. B is unknown from A because the network is use-centric and not user-centric;
“Co-option” shall be understood as a synonym of “trusted contact in referrals”;
“buzz” should be understood as the search, the need or the use in the system. A “buzzer” is an entity (a node) that has received the buzz;
“reverse propagation” should be understood as the virtual ascent of the generated network from each last node to the corresponding preceding nodes till the first node.

In the following description, the system is dealing with a job offer, but it could deal with any offer: sales/purchases, encounters, etc.

FIG. 2 shows a network system 1 that allows getting only linear reverse propagation chains 2, in respect of the propagation of a specific search, where each entity 3 in the chain 2 refers to a unique antecedent.

In reference to FIG. 3, we provide networking solutions dedicated to the sourcing of skills or information, which allows finding quickly and at low cost qualified applicants, recommended by trusted contacts. A system (hereafter “the system”) is installed on a network site, for example, an Internet site. The steps for running the system are the following ones:
4: Posting of a given offer by a user (or originator) 10 of level “zero” on the Internet site (invisible by the public);
5: Selection, by the user 10, of the “first nodes of chain” 20 of level “1” forming a first network of acquaintances, known directly and/or indirectly to the user, for example:
   the originator's employees corresponding to the applicant profile;
   possible external knowledge (personal network, former co-workers, rent database . . . );
   possible relevant profiles selected in complement in the profile base of the system.

To simplify the figure, only one first node 20 is selected.
6: Distribution of the offer by co-option through one or more intermediary entities 25 of levels “n”, unknown to the user and having each a network of acquaintance formed by contact with entities of level “n+1”, the system comprising a filter which runs at each incrementation level to linearize the network tree propagations by removing any entity contact duplication. The system may also comprise a filter which forbids each entity of level “n” to send the offer to more than x entities at a level “n+1”, x being specific to each originator, each offer and each level, and fixed between 0 to n.
The e-mail incites in clicking on a hypertext link to read online the detail of the offer. The promised reward in case of successful hiring urges to co-opt the relevant candidate via the site. Thus, the viral chains are traced up to the application by the system.
7: Ascent of recommended applications on the originator account:
   After an application, the system requests from the member 30 (the last but one node) who referred the final entity 40 unknown to the user and able(s) to satisfy the search a recommendation about him.
8: Automated call-back:
   Every applicant 40 receives an automatic e-mail for example 1 month after an application to ask for clarification if it ended by an acceptation of the answer; the reward paid to the one 30 who co-opted him in case of positive answer will incite him to supply this piece of information by simple e-mail reply. The same automation is done towards the originator 10.
9. Invoicing of the originator 10, and reward of the ones 20-25-30 who co-opted in case of success.

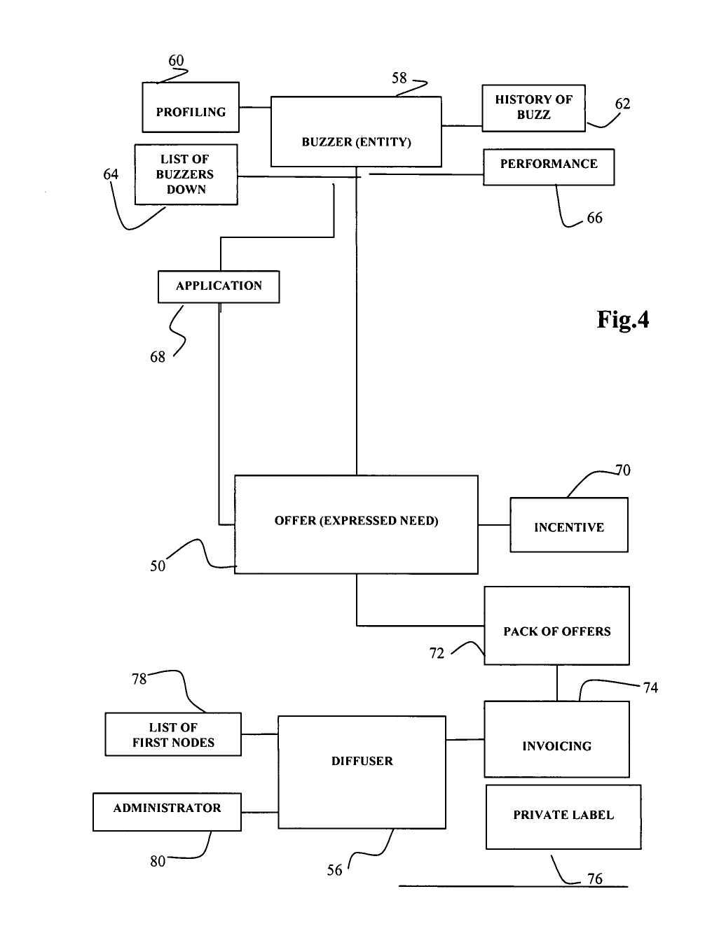

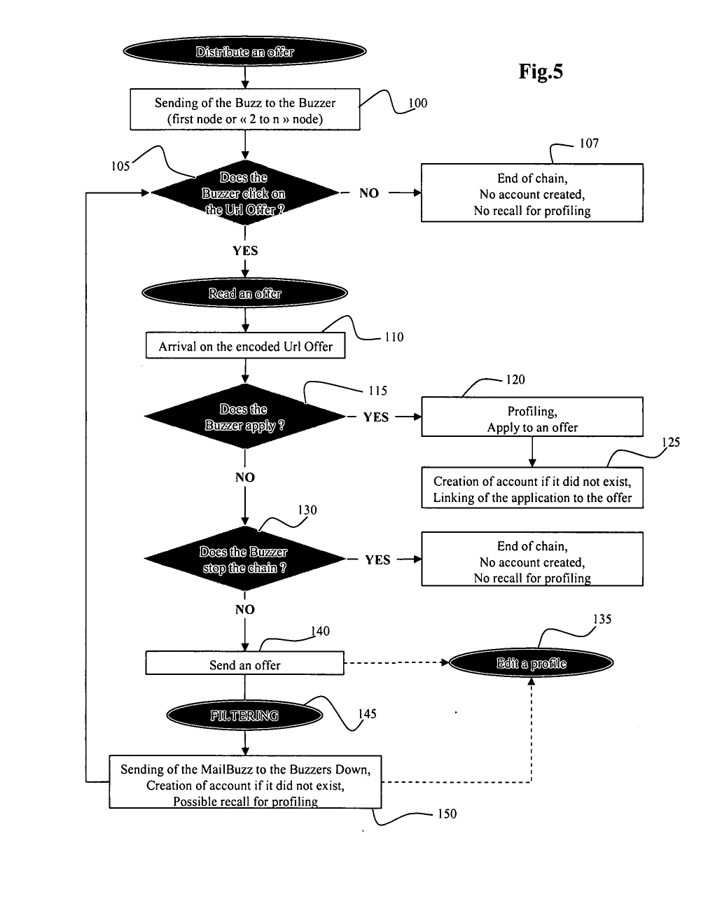

A conceptual model of data is presented on FIG. 4. The model considers the need as the unit: it is a use-centric linkage, hence the place of the table “Offer” between the table “Originator” and the “Buzzer” (entity) one within the conceptual model of data.

The table “Offer” 50 comprises the following fields:
Id_Offer (primary key of the table)
Originator internal code
Date of posting
Title
Skills
Location
Content of the offer
Criteria/Ranges of expectations
Contact E-mail
Mail First Node
Confidentiality (Intern, Private)
Maximum number of applications
Maximum number of nodes
Maximum number of recipients at level 1/2/n
Mission level
Mission costs
Status (To Valid/To Launch/Run/Done)
Number of Posted/Read/Accepted applications
Number of buzzers at node 1/2/n

More specifically, the fields “Title”, “Skills”, “Locations”, “Criteria/Ranges of expectations” correspond to the main characteristics of the offer that they can read in the synthesis e-mail.

The field “Skills” recover specific assessments expected by the originator, as for instance “Spoken language”, “level of studies”, “fields of scientist assessments”.

The field “Content of the offer” is the block text that details the offer. A click on the encoded URL of the synthesis e-mail charges it on the corresponding web page.

The field “Contact E-mail” can be different from the one of the originator, because the originator can be distinct from the one who proceed to the first selection of applications, for instance. It does not appear to the applicant, it is only used by the system to inform the responsible of the offer of news about the distribution or the applications, e.g. quota of applications exceeded, new applications received.

The field “Mail First Node” corresponds to the synthesis mail sent by the system after the validation of the offer by the originator. The field “From” can be anonymous: “System@System.com”, or not: “$Company@System.com”. It is the same for the “Subject”: “The system has selected for you this offer” or “$Company has selected for you this offer, with the system”. The field “Body” is made of a block text with personalized fields: a possible caution of the company if it is not an anonymous broadcast, the main characteristics of the offer—Title, Skills, Locations, Criteria/Ranges of expectations—, a marketing speech to present the advantages of the System service, and the encoded URL that leads to the detailed offer on-line. The field “Mail First Node” differs from the Mail Node, which is the synthesis e-mail that is forwarded after the first nodes till the end of the viral chains, on two points: firstly, the “from” and the “subject” resumes the information of the Buzzer Up: From: “ptodd@gmail.com”, Subject: “Peter Todd has selected this offer for you”; secondly, the possible caution of the company is replaced by a caution of the Buzzer Up—quotation of the name of the Buzzer Up or possible personal text edited by the Buzzer Up—for his recipients.

The field “Confidentiality and Maximum number of applications/nodes/recipients”: the system solution can give to a company who opted for a “private label” solution—a more personalized and parametrizable solution than the generic one—, an Intranet like http://company.co-option.com, which is based on the invention and proposes supplementary features of internal communication. For example, the possibility for the company to have a branded space of communication; the possibility for the originator to parameterize the maximal number of nodes by chain, to allow an operating manager to post offers while keeping the option of validation before distribution; the possibility for an employee to ask for introducing a viral chain for an offer while he had not been preset by the recruiter, and so on. Hence, the fields “Maximum number of applications/nodes/recipients”, cannot be superior to the characteristics attributed to the originator in the “Originator” table, valid for all his offers (see after). The field “Confidentiality” deals with the degree of visibility of the offer. Indeed, the offer is private by default, which means that it is only accessible to the candidates co-opted by the others within chains of e-mail. However, if the originator benefits from a private label, the originator can decide to publish it also in intern—so the offer is viewable by the employees on the intranet site, and they can decide to ask for introducing a new viral chain.

The field “Mission level/costs”: the pricing can be defined according to the level of difficulty of the answer to find. Thus, in considering the example of a job mission to provide, at least five distinct levels can be distinguished: trainee, non executive, junior, middle and top flyer executive. The originator specifies the <<Mission level>> field. The costs, them, correspond to the commercial grid affected to the originator, and mentioned in the table “Pack of offers”. The system enables, for example, to decompose the costs according to the Retainer model, used by the headhunters: the recruiter pays a part to the posting—the “cost of Posting”—, the other one to the ascent of the candidates—the “cost of Application”—, and the balance for the recruitment if he takes place—the “cost of Acceptation”.

The field “Status”: the system allows management of the posting rights: the originator can allow an operational originator, for instance a director of activity, to edit an offer without granting him the rights of posting; he will then be notified by e-mail to validate the aforementioned offer, and activate its distribution. Hence the four possible values for the “Status” field are: “To Valid” means that the offer has been edited by an operational originator and still waits for being validated by the administrator (see table “administrator”); “To Launch” means that either the originator has the rights of posting, or he has not but the offer has already been validated by the administrator, and now waits for being launched; “Run” means that the offer has been launched, and is still distributed; “Done” means that the distribution has been stopped. When the status is “Done”, someone who would click on the encoded URL, in order to access the detailed offer, arrives on a generic web page explaining that the offer is now expired, and so that it is unfortunately too late for applying.

The fields “Number of Posted/Read/Accepted applications” and “Number of buzzers at node 1/2/n” are counters of all applications linked to the offer, and are resumed on the originator back-office. The latter is a web-based tool that enables the originator to manage an account—professional information and rights of publication—, offers—create, modify, valid, launch and stop an offer—, contacts—the first nodes of the offers already launched through the system—, and applications—the applicants' resume and cover letter, and the recommendation by the buzzers who co-opted them—.

The table “Originator” 56 comprises the following fields:
Id_Originator (primary key of the table)
Company
First name, Last name
E-mail (login)
Password
Phone number
Fax number
Invoicing information, contact and address
Rights of posting
Id_Administrator (identifier of the possible administrator connected hierarchically with him)
Maximum number of nodes
Maximum number of recipients at level 1/2/n

More specifically, the field “Rights of posting” defines whether the originator has the right to launch an offer, or if the originator is only an operational originator, and if an edited offer will need to be validated by the administrator he is linked to.

The fields “Maximum number of nodes/recipients”: the system comprises means for limiting the search progress according to a degree of confidentiality given by the user or by the system itself. This field may be set by the system to avoid generating too many broadcast distributions, and value the “Private Label” by according a larger number of nodes and recipients at level 1/2/n by distribution. This field may also be set by the originator. For example, if the originator wants to focus only on the nearness network, the originator can decide to set a smaller limit for a particular offer, inferior to the maximum he as the right to.

The table “Buzzer” 58 comprises the following fields:
Id_Buzzer (primary key of the table)
Date of creation
First name, Last name
E-mail 1 (login)/2/3
Password
Date of birth
Address
Frequency of reception
Status (first buzzer/private buzzer/external buzzer)

More specifically, the field “E-mail” is the member login. A member can provide three distinct e-mail addresses to be easily recognized as part of the community when the originator is one of the recipients of a buzz.

The field “Frequency of reception” enables the member to choose how often to be informed of new offers corresponding to a profile; it can be for instance once a day, once a week, once a fortnight.

The field “Status”: there are three distinct status. A member can be a first buzzer, which means having at least one complete profile, and may be selected by the user as a first node; also can be a private buzzer, which means that the e-mail address has been only specified by an originator, as a first node, and has not decided to fill a profile yet; and can be an external buzzer, which means already being co-opted by an acquaintance who is not an originator, and that has not filled a profile yet—but in that case, contrary to the private buzzer, the originator will receive automatic e-mails to do so: see hereafter.

The table “Profiling” 60 comprises the following fields:
Id_Profile (primary key of the table)
Name of profile
Type of profile (seeker/head-hunter)
Activation (yes/no)
Skill 1/2/n
Location
Field 1/2/n

A buzzer can define from 0 to n distinct profiles thanks to the fields “Skill 1/2/n”, “Field 1/2/n”. For as long as the user has no profile, the user is a simple buzzer—a private or an external one—; as soon as the user has at least one, the user becomes a first buzzer, which means that the user can be found on the user's profile's characteristics by originators and be selected as first node of viral chains.

The interest to manage different profiles for a buzzer includes being able, for instance, to receive targeted offers for different personal assessments, or to have one profile for self-assessment, candidate, and others for hunting in his circle of acquaintances and being rewarded for it. Hence the possibility for a buzzer to define the type of each profile, either “seeker” or “headhunter”, and to activate only some of it.

The table “History of buzz” 62 comprises the following fields:
Id_Historical (primary key of the table)
Id_Offer (identifier of the offer)
Id_Incentive (identifier of the incentive; see table “incentive”)
Id_Buzzer Up (identifier of the Buzzer Up)
Node number
Number of Buzzers Down
Id_Registered Buzzers Down
Applicant (yes/no)
Applicant Down (yes/no)
Id_Applicants Down (identifier of each applicant at a level n+1 or more)
Win Buzzer: Yes/Run/No
First node employee (Yes/No)
Amount Win First node employee
Premium Code
Use of Premium: Yes/No

More specifically, the “node number” is a means for identification of each entity level in each search progress linear chain. Combined with the offer identifier and the Buzzer Up identifier, it enables to locate precisely the buzzer within the generated network, and to rebuild the chain till the right first node. The node number is also a precious information for the originator (see table “Application”).

The field “Number of Buzzers Down” is a count of distinct recipients; this field is null as soon as long as the buzzer has not forwarded the offer.

The field “Id_Registered Buzzers Down” is an identifier of each recipient who was already registered in the database, or who decided either to forward the offer or to apply for it.

The field “Applicant” is at “no” when the buzzer has not applied for the offer, and at “yes” when the buzzer has applied for the offer.

The field “Applicant Down” is at “yes” as soon as at least one person applied for the offer at a level “n+1” or more, following to his forward.

The field “Win Buzzer” is at “Yes” if the buzzer belongs to the winning viral chain for the specific offer identifier; it is at “No” if the distribution has been stopped by the originator because the originator has found yet (thanks to the system or not) or has decided to freeze the search, and if the user does not belong to the winning viral chain; it is at “Run” as long as the user is not part of the winning chain, and as the offer keeps on being distributed.

The fields “First node employee, Amount Win First node employee”: the system also allows attributing a different reward to the first node as it is about a wage-earning person of the company having emitted the offer—possible financial payment in that case. Hence, a field “First node employee” that specifies whether the buzzer is implicated as an internal first node—an employee selected as a first node by the recruiter: see hereafter—. If yes, and if the user results be part of the winning viral chain: “Win Buzzer: Yes”, the user can receive a financial payment which amount is resumed in the field “Amount Win First node employee”. This parameter is initially set by the originator before launching the offer, and is written in the “Incentive” table, linked to the offer.

The fields “Premium code, Use of Premium”: if the buzzer belongs to the winning chain that leads to a retained application, the user earns a premium, distinct according to the place in the chain: first node of the chain, middle node, or last but one node (the last one before the applicant). In a preferred embodiment of the invention, the first node and the last but one node of the winning chain earn a reward superior to the intermediate nodes. The three category of premium are defined by a code in the “Incentive” table; the appropriate code is resumed in the “Premium code” field of this table. The buzzer can access to a specific web page to find all necessary information in order to receive the premium. Once validated this web page, the field “Use of premium” turns to “Yes”, which prevents the user from asking for it twice. As opposite to the “Amount Win First node employee”, the values of premium should be set by the system.

The table “List of Buzzers Down” 64 comprises the following fields:
Id_List (primary key of the table)
Id_Buzzer (identifier of buzzer)

It aggregates identifier of all distinct persons the user has already forwarded offers to, whatever the offer is.

The table “Performance” 66 comprises the following fields:
Id_Performance (primary key of the table)
Total number of chains
Number of chains in the last 6/3/1 months
Number of Application chains
Number of Acceptation chains
Number of Buzzers Down

It counts the buzzer's action since the subscription: number of viral chains to which the user has belonged, number of chains having generated an application or having been retained by the originator, and “number of Buzzers Down”, which counts the number of distinct persons to whom offers have been forwarded.

The table “Application” 68 comprises the following fields:
Id_Application (primary key of the table)
Date of Application
Content 1/2/n
Node number
Length of the chain
Status (Posted/Read/Accepted/ . . . /Not Accepted)
Acceptation (YesConfirmed/Yes/Run/No/NoConfirmed)
Id_Buzzer Up
Text of recommendation

More specifically, the field “Content”, from 1 to n, constitutes the answer of the applicant. It can be any specific data, as for instance “Level of experience for such field”, “Area of possible relocation”, “Availability”, “Telecommuting”, “Spoken languages”, and so one. It can be block texts to express motivations, or other additional information. It can be uploaded files, as for instance, schemes, pictures, sound files, resume, or memorandum.

The field “Node number” is a precious information for the originator; it will so appear on the applications tracking sheet of the back-office, so that the user can choose to privilege an application which node number is smaller than another one: the smaller the node number is, the shorter the chain till the applicant is. And the less widely broadcast the co-option is: hiring someone co-opted by someone you know is more reassuring than someone that applied at five degrees from you.

The field “Length of the chain”: another figure that is resumed here to gain performance in the posting of the dashboards of the originator, on the back-office. Indeed, for each offer, the originator can appreciate the strike force of the broadcasting: total number of members informed of the offer, and detail by level of node.

The field “Status”: the status of the application can take one of the following values: “Posted”, which means sent but not read yet by the originator; “Read” but without any comments from the originator (a simple click on the details of the application); “Accepted” (retained by the originator); “Not accepted” (not retained by the originator); and any intermediary comments between accepted and not (“Interesting”, “Very interesting”, “To read again”, for instance . . . ).

The field “Acceptation”: the response of the applicant following the automated call-back prevails on the status set by the originator. Thus, if the applicant answers that his application has been “Accepted”, whereas the status is still at “Very interesting”, the “Acceptation” field turns automatically from “Run” to “Yes”, and waits for a manual validation from the System team (“YesConfirmed”) before triggering invoicing of the originator—“cost of Acceptation, only in case of a “Retainer model”, see before—and the payment of premium to the members of the winning chain—in any case, “Retainer model” or not.

The field “Identifier Buzzer Up” is the identifier of the member who co-opted the applicant (the last but one node), the latter having to emit a recommendation.

The field “Text of Recommendation” is a simple block text, which is the recommendation emitted by the Buzzer Up about the applicant. Since the user posted it, this field is blank, and the link “Ask for a recommendation” appears next to the application 3 days after the application, on the originator's back-office, so that the originator can request for it.

The table “Incentive” 70 comprises the following fields:
Id_Incentive (primary key of the table)
Amount Win First node employee
Id_Premium Win First node
Id_Premium Win Middle node
Id_Premium Win Last but one node

More specifically, as explained in the comments for the table “History of buzz”, if the buzzer results to be a First node employee part of the winning viral chain—the field “Win Buzzer” is filled with “Yes”—, the user will receive from the company a financial payment which amount is set by the originator, and registered in the field “Amount Win First node employee” of this table.

The fields “Id_Premium Win First node/Win Middle node/Win Last but one node”: the buzzer who belongs to the winning viral chain earns a premium, distinct according to the place in the chain: First node, Middle node, or Last but one node—the last one before the applicant—. The different identifiers correspond to the code of the different premiums, the equivalence between code and premium being treated outside the database, for reasons of flexibility.

The table “Pack of Offers” 72 comprises the following fields:
Id_Pack (primary key of the table)
Date of subscription
Credit by level of mission
Cost of Posting by level
Cost of Application by level
Cost of Acceptation by level

The fields “Date of subscription” and “credit by level of mission”: it can be considered that selling one short mission and selling a pack of offers is different and should be invoiced with a decreasing price scale (for instance 3, 10, 50, 100, 500 missions, and unlimited packs). This incites originators to buy large number of offers each year. More, as explained in the table “Offer”, the unit price can be defined according to the level of difficulty of the answer to find, hence the necessity to know the date of subscription of the pack, and the distribution of credits by level of mission.

The global pricing depends on the level of mission. Then, the field “Cost of Posting/Application/Acceptation by level” is decomposed in three parts, one for the posting: the “cost of Posting”, another one for the ascent of the candidates: the “cost of Application”, and the balance for the recruitment if he takes place: the “cost of Acceptation”.

The table “Invoicing” 74 comprises the following fields:
Id_Invoicing (primary key of the table)
Code of transaction
Amount
Date
Label

This table lists all transactions that are passed on the originator account: deduction, credit note, and abandonment of pay.

The table “Private Label” 76 comprises the following fields:
Id_PrivateLabel (primary key of the table)
URL
Logo
CSS (cascade style sheet)
Text on Home Page
Field 1/2/n

All the fields “URL, Logo, CSS (cascade style sheet), Text on HomePage, and eventual additional Field 1/2/n” enable the company who bought a Private Label to have a branded space of communication. The URL can be like http://company.co-option.com, the logo can be the one of the company, the CSS can respect the chart of the institutional web site of the company, and so on.

The table “List of First nodes” 78 comprises the following fields:
Id_List (primary key of the table)
Id_Buzzer
Type (Employee/Non employee/Database member)
Statistics

The fields “Id_Buzzer and Type” aggregate all first nodes that the originator has already defined for the distribution of offers. When an originator decides to distribute an offer next time, the originator can select one or more persons of this list, and add some else if the originator considers that for this particular offer, it is worth informing them. For each originator's first node, the originator also should decide whether it is an employee or not—personal network, former co-workers, rent database. Thanks to that, the system knows if the originator is concerned by the payment of the “Amount Win First node employee” in case of success. An originator's first node can also be a database member, which means that the originator found him following to a search on the profiled members of the database—the first buzzers—.

The field “Statistics” is a counter of the efficiency and the wear of the buzzer's activity, considering the offers that have already been received by the originator: “efficiency statistics” counts the total number of offers sent by the originator to the Buzzer Down, the number of offers the latter has forwarded, the number of offers that ended in an application, and the number of offers that ended in an hiring; “wear statistics” counts the number of offers sent by the originator to the Buzzer Down for example in the last 6 months, in the last 3 months, and in the last month. This allows an originator to avoid an overexploitation of its network of acquaintances.

The table “Administrator” 80 comprises the following fields:
Id_Administrator (primary key of the table)
Company
First, Last name
Function
E-mail (login)
Password
Phone number 1/2
Fax number
Invoicing information, contact and address
Rights of posting
Id_Originators (identifier of the possible originators connected hierarchically with him)
Maximum number of nodes
Maximum number of recipients at level 1/2/n

An originator can optionally depend on an administrator. If yes, it means that the originator does not have the rights of posting; once the offer is edited, the administrator connected will receive automatically an e-mail to validate the aforementioned offer, and activate distribution from then on.

The system described here above is use-centric, instead of user-centric. It is an open system for dynamically generating a network of contacts that builds as many distinct networking databases as number of needs or searches expressed. In terms of meshing, it comes to register the network of each member at the first curtain only: in the database, each buzzer is connected to the table 64 “List of Buzzers Down”, which aggregates identifiers of all distinct persons to whom offers have already been forwarded, whatever the offer is. When a buzzer decides to distribute an offer next time, the originator can select one or more persons of this list, and add someone else if the originator considers that, for this particular offer, it is worth informing them.

So, with this use-centric linkage, a member remains the only person aware of the potential of each acquaintance, at the second or the third level, and the only one to decide whether he wants to distribute an offer, insofar as the relationships between users stops at one level in the database: it is only the distribution of the need that create chains. Hence, a meshing that is not frozen, always private, and ceaselessly renewed, according to the distributions of offers.

Concerning the confidentiality of the distribution: the first nodes of chains, entities of level “1”, are defined by the originator; the following one, entities of levels “n”, are the object of an electronic co-option by their antecedent, entities of levels “n−1”, in the chain: the offers are finally only accessible to the candidates co-opted by the others within chains of e-mail. There is effectively no possibility for a candidate to search for an offer on a specific field or on keyword on the Internet site.

Technically, it involves the use of encoded URL in the e-mails of synthesis broadcast after a co-option. The co-opted person who receives this e-mail can read the main characteristics of the offer, and decide to click on the URL to reach the detailed offer on the corresponding web page.

The system allows implication by the recommendation: after an application, the system sends an automatic request by e-mail to the member who co-opted the applicant—the last but one node—, so that the member emits a recommendation about the applicant. If the member forgets to do it, the originator can also request for it by clicking on the appropriate link: “Ask for a recommendation”, that appears in such case next to the application, three days later, on back-office. The recommendation is written in a block text, on a dedicated web page; it aims at reinforcing the implication of members when they decide to co-opt somebody, to favor the relevance of the distribution, and of course to help the originator in selection by offering additional information about the applicant.

The system, which is a web-based service of co-option, enables receipt of offers to apply for it or broadcast them in the circle of acquaintances, and to be rewarded for it. The system further comprises means for remunerating the entities in function of their effectiveness and/or their goal in the search success—persons enabled to pick up the winning profile—, by offering remuneration to each of the nodes of the winning viral chain. The remuneration can be a pecuniary remuneration, a payment in kind, a payment in points or a payment in advantages.

Thus, in every stage of the distribution of a need, the system identifies in a unique way every viral chain, and histories electronically each of the members having possibly received and pursued the distribution of the offer, until it succeeds either in the end of a chain, or in an application on behalf of the last node. The first node and the last but one node of the winning chain earn a reward superior to the intermediate nodes. The system also allows attributing a different reward to the first nodes as it is about a wage-earning person of the company having emitted the offer—possible financial payment in that case—.

Considering every candidate as a potential head-hunter, and giving an appropriate incentive, are a guarantee of efficiency on the market of the co-option: a greater buzz, a longer fidelity to the service, a larger relevance in the distribution, and a faster constitution of a wide and deep base of profiled seekers/head-hunters.

The system guaranties uniqueness of the receipt. The fact that the meshing is use-centric enables a complete traceability of the distribution. By defining first nodes, the originator generates viral chains, constituted of nodes that refer to specific identifier of members in the database. From then on, when a buzzer chooses to forward an offer to another person, the system verifies that this one has not already received the offer in question. In other words, the system comprises a filter which runs at each incrementation level to linearize the network tree propagations by removing any entity contact duplication. The filter comprises means for removing, accordingly to each search, a contact duplication between the networks of acquaintances of each intermediary entity, so that each entity of level “n+1” in the chain refers to a unique entity of level “n”.

Thus, the system may comprise:
a database 62 concerning the search progress history and comprising contact information of entities already contacted in the course of the progress of this search,
means for compilation the database 62 in the course of the search progress by an entity towards its network of acquaintances, and
means for activating and/or inactivating contact information of entities of network of acquaintances in the course of the search progress to a higher level according to the absence and/or the presence of the contact information of entities already contacted in the course of the search progress.

The filter may remove, in each incrementation level, interconnection between each search progress chain by comparing statistical data concerning the intermediary entities according to the selection chronology of the “n” level entity.

Therefore, the system checks if the e-mail of the person addressee corresponds to one of the e-mail addresses of a member of the profile database 60.

If it is not the case, the system sends the offer, and the identifier of the offer is added in the table “History of buzz” 62.

If it is the case, the system checks if the identifier of the offer is already listed in the table “History of buzz” 62 of the member.

If not, the offer is sent. If yes, it means that the member has already received this offer by somebody else, and will not receive it a second time.

There are four goals in this uniqueness of the receipt: avoiding polluting the members, allowing a unique traceability in case of winning viral chain, encourage members to broadcast quickly, and calculating efficient statistics, without duplication, for example on the dynamic generation of a network of contacts, on the network tree propagations, and/or on the effectiveness of each entity.

In every case, even if they had already received the offer by a third, the new Buzzers Down—the addressees who had still never received from this buzzer—, are added to the “List of Buzzers Down” 64 of the sender.

By concern of performance, because these various actions risk entailing a too consequent load for the server, this check before sending and adding the new buzzers should be treated in batch, for example, several times a day.

The filter may remove, in each incrementation level, interconnection between each search progress chain by comparing statistical data concerning the intermediary entities according to at least one criterion. The criterion is taken in the group consisting of the respective effectiveness of the entities which has selected the n level entity, the level of the entities which has selected the n level entity.

The e-mail of an entity, unknown by the system and contacted by a node, is systematically registered in the profile database 60. To improve the quality of this database, this poor profile should be developed by the entity. Therefore, to increase the number of well-profiled members in the database 60, the system generates automatically an e-mail to the nodes with following characteristics:
the node number is greater than 1: no first node receives such e-mail to protect the confidentiality of the address book of the originator;
the buzzer has forwarded one offer (if the buzzer applied for it, the buzzer already has to do a profile; if the buzzer did neither apply or forward, the account is not created);
the date of creation of the account goes back to 1 week and 1 month (which comes to say that a buzzer is recalled twice, after 1 week and 1 month, even if the buzzer receives and forwards several offers without having ever profiled);
and the buzzer has not profiled yet (the nodes for which specific characteristics like Skills/Location are not known),

so that they can benefit latter from future offers corresponding to their profile, as first nodes. Indeed, when specifying the first nodes before launching an offer, an originator can choose to complete a personal network with profiled members of the profile database 60—the first buzzers—, members that would have found thanks to a search on said database 60: the relevance in the results considers the degree of matching of the characteristics of the member, but also ratings of performance.

So, somebody who received an offer from an acquaintance, and who did not know the service beforehand, will receive an e-mail one week and one month later—by batch treatment—that underlines the functioning and the interest of such service of co-option, and that invites him to click and join the community of profiled members.

A rating of the buzzers is allowed by an open system for dynamically generating a network of contacts according the invention. The system further comprises:
a statistics database 66 concerning the effectiveness of each entity,
means for compilation the database according to the search,
means for selecting an entity according to its effectiveness.

For example, the effectiveness of a given entity is represented by a criterion as the relevance of the entities that the given entity has contacted in the course of successful searches previously emitted in system, the sphere of activity of the given entity, the type of the given entity job, the number of different entities previously contacted by the given entity, and a combination of these criteria.

As explained before, the power of the technology of meshing and traceability of the system allows to show in a very simple way the promise of efficiency of the tool: so, every originator finds detailed statistics about each member, concerning efficiency and wear (see before) as a head-hunter, and is able to appreciate the strike force of the broadcasting. Thus, within the database 60, each member is linked to the “Performance” table 66, which counts as an action since the subscription: number of viral chains as a member since the beginning/since the last 6/3/1 months, number of chains having generated an application or having been retained by the originator, and “number of Buzzers Down” 64, which counts the number of distinct persons to whom offers have been forwarded.

The system can further include means for traceability of the search history comprising each action of the entities, and the effects generated by these actions.

The system of automated call-back enables to qualify the answer given by members.

As for any mission of hunting, it is indeed necessary to make sure if one of the applications presented to the originator has been accepted, this to be able to charge the balance of the mission.

Currently, companies of sourcing, like headhunters, in the employment field, are used to call back by phone every presented applicant: it is called Call-back, or Recalling, an expensive and boring process.

Our system allows automating this function of confirmation of the acceptation, thanks to the traceability.

Concretely, every applicant receives an automatic e-mail one month after application to clarify if it ended by an acceptance of the answer; the reward paid to the one who co-opted the applicant in case of positive answer will incite the applicant to supply this information by simple e-mail reply. The same automation is done towards the originator.

The system allows a real feedback on the relevance: in addition to the “Performance” table 66, each member is connected to the “History of buzz” table 62 and the “Application” table 68 within the database, so that all information given by the originator concerning the offer—date of posting, current status, level of the possible node retained, degree of satisfaction of all applicants—, and registered by the system—number of chains generated, number of members informed at each linked, status of call-back for each applicant—enable the originator to value at the same time the clarity of demand, the relevancy of the network, the plurality and the quality of all members, and finally the performance of the application.

In FIG. 5, the first step 100 of the distribution of an offer by the system is sending the buzz (offer) to the buzzer beforehand chosen by the user—which can be either the recruiter if the recruiter is a first node or an acquaintance if the recruiter belongs to the node “2” to “n”—. For example, an e-mail could be:
In case of first node:
   From: “System@System.com” (anonymous), “$Company@(System.com” (not anonymous)
   Subject: “the system has selected this offer for you” (anonymous), “$Company has selected this offer for you, with the system” (not anonymous)
   Body: No caution (anonymous), Caution 1st level ($Company) (not anonymous)
   Characteristics of the offer ($Offer)
   Marketing speech presenting the advantages of the system service
   Encoded URL leading to the offer ($UrlOffer)
In case of node “2” to “n”:
   From: “$BuzzerUp@System.com”
   Subject: “$BuzzerUp has selected this offer for you”
   Body: Caution 2nd level ($BuzzerUp)
   Characteristics of the offer ($Offer)
   Marketing speech presenting the advantages of the system service
   Encoded URL leading to the offer ($UrlOffer)

On step 105, if the buzzer does not click on the URL offer, the system will not send, on step 107, any incentive e-mail to profiling even if the buzzer is not profiled yet, insofar as the buzzer has neither forwarded the offer nor applied to it.

If the buzzer clicks on the URL offer, it means that the buzzer wants to read the offer to apply or to send it to a particular network of acquaintances. Therefore, the system displays the offer on step 110 by opening the web page where the offer is stored.

In this page, the system displays the offer details: Company, Sector, Job title, Location, Wages, Level, Contact, and Content, an URL “ApplyToThisOffer”, and an URL “SendThis Offer”.

On step 115, if the buzzer applies to the offer by clicking in the URL “ApplyToThis Offer”, the system creates, on step 120, an account: First and Last Name, Mail, Password. The buzzer has to edit his profile and upload documents: resume, cover letter, photo, etc.

On step 125, the system links the application to the offer by filling the different fields of the table 68. The system sends an e-mail to the member who co-opted the applicant to get a recommendation.

On step 115, if the buzzer does not apply, the system looks, at the step 130, if the buzzer stops the progress or not. If yes, the system will not create an account and will not send, on step 135, any incentive e-mail to profiling even if not profiled yet. If no, it means that the buzzer wants to send the offer, step 140, to the network of acquaintances.

After filtering on step 145, the system sends the offer, on step 150, to the entities buzzers down—selected by the buzzer, on step 140, in the network of acquaintances and retained by the system—non stopped by the filtered—. The not retained buzzers down—stopped by the filter—are, nevertheless, linked to the buzzer account for statistical calculation by the system and improvement of the efficiency by the system itself. The buzzer has to specify their first and last names and e-mail address. A personalized text—block text—can be recorded. Then, the system creates an account—if it did not exist before—and displays the issue of the sending to each recipient: the one that has not been sent because the recipient has already received the offer by someone else, the one that has succeeded, and the possible failures. The web page displayed also request the buzzer for profiling. At least, the system will also send incentive e-mail to profiling one week and one month after the date of creation of an account, if not profiled yet and if belonging to the node “2” to “n” (as explained before, no first node receives such e-mail to protect the confidentiality of the address book of the originator).

This is interesting for a buzzer to be profiled for another search. The profile is stored in the table “profiling” 60 (FIG. 4). The field “Profiled” corresponds to a First buzzer, which means a buzzer having specified the fields Job/Age/Function/Sector/Location; The field “Nonprofiled” corresponds either to a buzzer known by the user, who has been registered with the only information First name, Last name, E-mail and Type: employee/non employee, and who has never belonged to the node “2” to “n” of a posterior viral chain, or to a buzzer who has already been co-opted by another buzzer, node “2” to “n” of a viral chain, but who has not profiled following the requests for profiling of this chain, one week and one month after the creation of the account. The fields for profiling can be used by the system and/or the user to make a filter in the profile database 60 in order to select profile and improve efficiency of the offer progress.

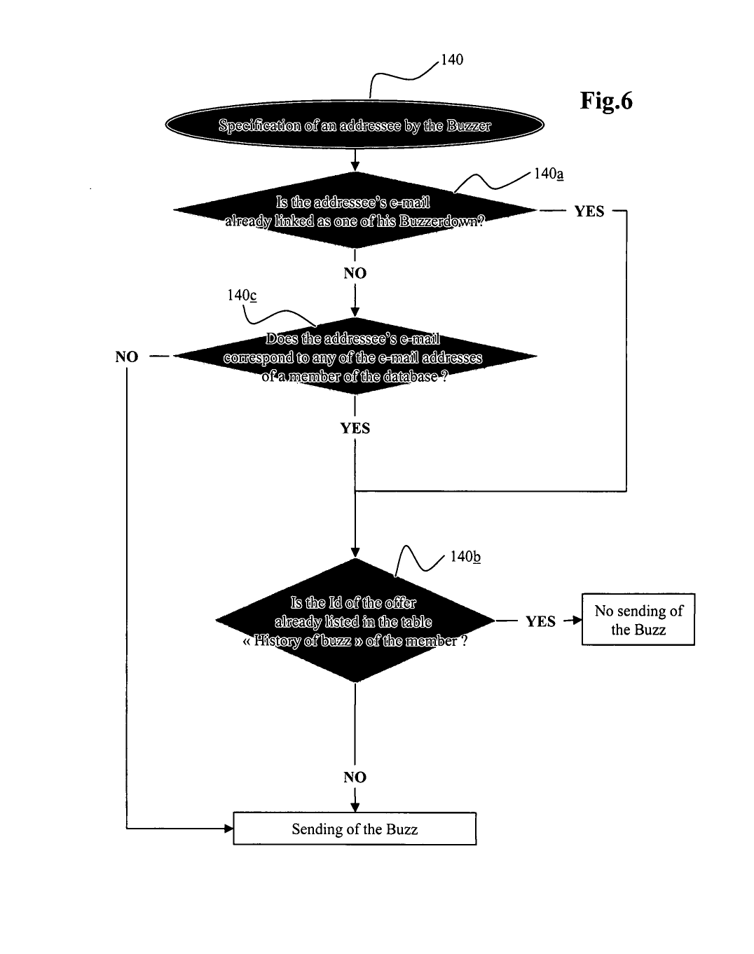

FIG. 6 focuses on the uniqueness of the receipt by a Buzzer Down thanks to a filter based on a chronology comparison.

On step 140, the buzzer specifies the e-mail of the entities the buzzer thinks could be interested in the offer.

On step 140a, the filter tests whether the addressee's e-mail is already listed in the “List of Buzzers Down” (table 64) of the buzzer, it means if the buzzer has already contacted this entity in a previous search.

If yes, the filter tests, on step 140b, whether the identifier (Id) of the offer is already listed in the table “History of buzz” 62 of the member.

If the answer on step 140b is yes, that means that the addressee has already received the offer by another entity in the network of contacts generated by this given search. The filter stops the progress towards this entity by not sending the offer for removing, accordingly to this search, a contact duplication between the networks of acquaintances of each entity. It means that any antecedent considered as entity is made unique and the reverse propagation towards the Buzzers Up is linear. In this example, the removing is made a priori, i.e. before any sending, but it could be made a posteriori, i.e. by keeping only one antecedent between several sendings from different senders, regarding the quality or the effectiveness of the sender, or based on the choice of the addressee to forward or to apply for the offer coming from a preferred sender.

When the filter stops the progress, the addressee will be reported as “Already sent” on the web page displayed by the system to the sender. The addressee is added to the “List of Buzzers Down” 64 of the sender, if it was not the case yet.

If the answer on step 140b is no, that means that the addressee has not yet received this offer, and the filter allows the incrementation level by sending the offer to the Buzzer Down.

If the answer on step 140a is no, the filter tests, on step 140c, whether the addressee's e-mail correspond to any of the e-mail addresses of a member of the database 60.

If the answer on step 140c is no, the next step for the filter is the step 140b and the conclusions are the same as here above.

If the answer on step 140c is yes, that means that the addressee has never received any offer. The filter allows level incrementation by sending the offer to the Buzzer Down.

When the filter sends the offer, the Id Offer is added in the table “History of buzz” 62 of the addressee. The addressee will be reported as “Successfully sent” or “Failed” on the web page displayed by the system to the sender, as the e-mail address is valid and as the e-mail arrives at destination or not. The addressee is added to the “List of Buzzers Down” 64 of the sender if it was not the case yet.

The system may comprise a statistics database concerning the effectiveness of each entity, means for compilation of the database according to the search, and means for selecting an entity according to its effectiveness.

In this case, the filter uses the means for selecting an entity according to its effectiveness in order to remove entity contact duplication. Therefore, the filter tests the effectiveness of a given entity represented, for example, by the relevance of the entities that the given entity has contacted in the course of successful searches previously emitted in the system, the sphere of activity of the given entity, the type of the given entity job, the number of different entities previously contacted by the given entity, and a combination of these criteria.

For example, if the criterion is the relevance of the entities that the given entity has contacted in the course of successful searches previously emitted in the system, the filter will send the e-mail to a Buzzer Down from the given entity who has contacted the largest number of relevant entities. An other solution could be that the filter will send the e-mail to a Buzzer Down from the entity who was in the largest number of winning viral chain in course of successful searches previously emitted in the system.

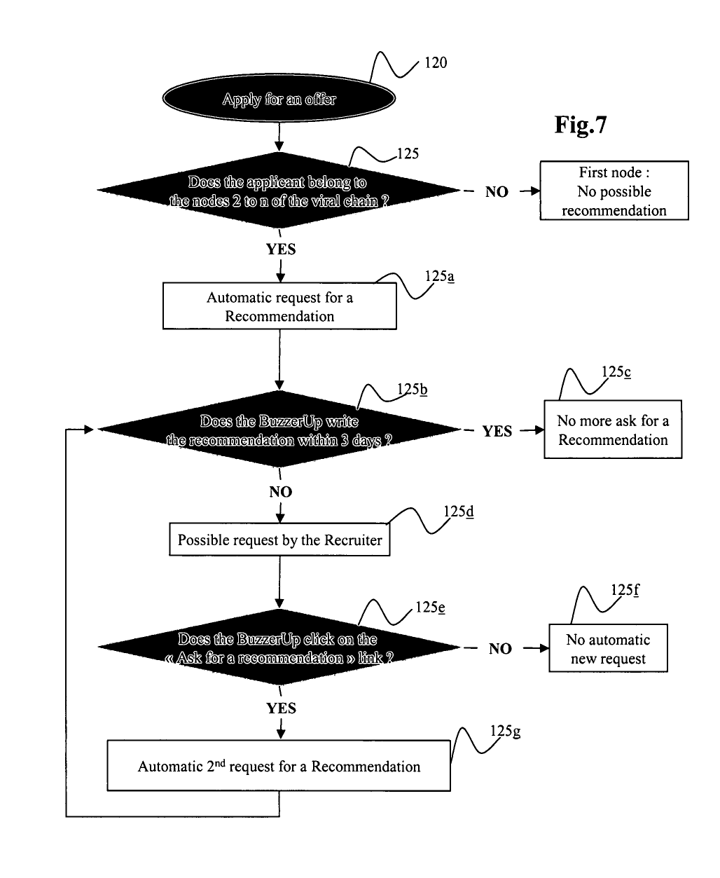

FIG. 7 focuses on the recommendation, which is a means for improving the efficiency of the system. Indeed, a node who knows that the node will have to recommend an applicant, will only contact relevant entities for the offer.

When an applicant applies for an offer (step 120), the system looks, on step 125, if the applicant belong to the nodes of level “2” to “n” of the viral chain.

If the answer is no, it means that the applicant is one of the entities directly contacted by the user. A request of recommendation is useless, because the user knows directly this applicant.

If the answer is yes, the system sends, on step 125a, an automatic request for recommendation to the applicant's Buzzer Up (the previous node in the chain), which is useful because the applicant is unknown by the user, with regards to the offer.

The structure of the e-mail could be:
From: $BuzzerDown@system.com
Subject: “I need your recommendation for my application”
Body: “Thank you to take a few minutes to write a short recommendation on me. With this recommendation, if I am hired, you will be rewarded!”. The body further comprises the URL Recommendation.
The field “Text of Recommendation” shows “Asked for it on DDMMYY. Please wait” on the Recruiter's back-office.

Then, the system tests, on step 125b, whether the Buzzer Up wrote the recommendation within, in this example, 3 days. If yes, the system, on step 125c, no more asks for a recommendation, and fills the field “Text of Recommendation” on the Recruiter's back-office.

If the answer is no, the system, on step 125d, let the field “Text of Recommendation” in blank on the Recruiter's back-office, and displays a link “Ask for a recommendation” next to the application, so that the originator can request for it by a simple click on it.

On step 125e, the system looks if the Buzzer Up clicked on the “Ask for a recommendation” link. If the answer in no, the system does not send, on step 125f, a new request for recommendation. If the answer is yes, the system sends, on step 125g, another request for recommendation to the applicant's Buzzer Up.

The field “Text of Recommendation” shows “Asked for it on DDMMYY. Please wait” on the Recruiter's back-office, and the system goes back to step 125b.

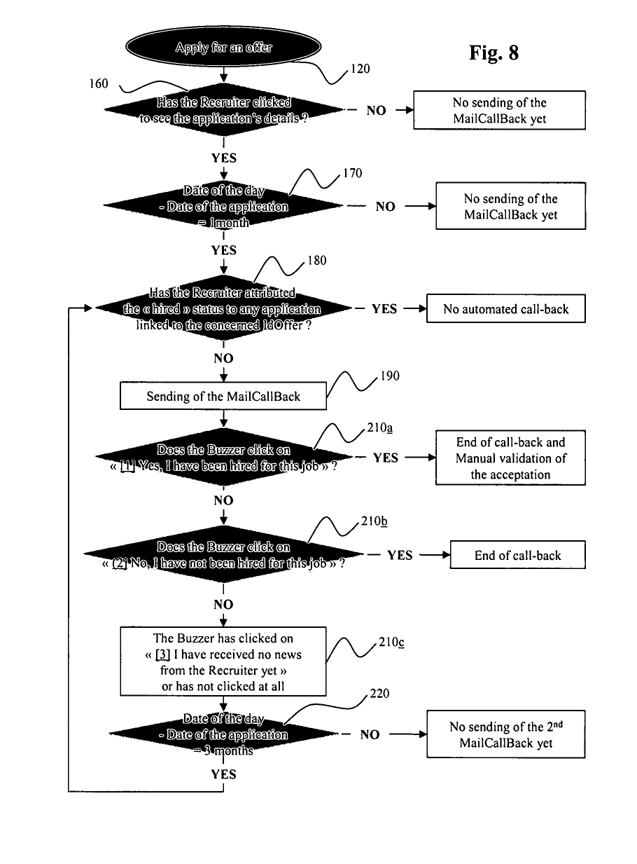

FIG. 8 focuses on the Call-back, or Recalling, which is a means for improving the efficiency of the system. Indeed, the Call-back gives a lot of information on the winning chain: how many nodes are present on this chain, who the nodes are, etc. This information is stored in the statistics database and used to improve the system in the following searches.

When an applicant has applied for an offer (step 120), the system looks, on step 160, whether the user (recruiter) has seen the application details. In these details, the complete profile of the applicant is available. At this step, the recruiter can make a direct contact with the applicant, out of the system. Therefore, it is important to be sure that either the recruiter or the applicant will inform the system of the search success: hence, the system may invoice the recruiter, it triggers the payment of premium to the members of the winning chain and makes statistics to improve the following searches.

If the answer is “no”, the system does not send a call-back mail to the applicant. If the answer is “yes”, the system looks, on step 170, whether the time between the date of the day and the date of the application is equal to one month. If it is less than one month, the answer is “no”, and the system does not send a call back mail to the applicant. If it is equal to one month, the answer is “yes” and the system looks, on step 180, whether the recruiter has informed the system of the search success by attributing the status “hired” to any application linked with the concerned Id offer (table 50).

On step 180, if the answer is “yes”, the recruiter has informed the system, and it is not necessary to send an automated call-back. If the answer is “no”, the system, on step 190, send to the applicant an automated call-back mail which structure could be:
From: Candidature@system.com,
Subject: <<Your application Name Company>>
Body: <<Thank you to specify whether you have been hired <if not First node> in order to reward your Buzzer Up in case of success>>.
Three distinct Submit Buttons:
   <<[1] Yes, I have been hired for this job>>
   <<[2] No, I have not been hired for this job>>
   <<[3] I have received no news from the Recruiter yet>>

On steps 210a, 210b, 210c, the system tests the answer of the applicant.

On steps 210a, if the answer of the applicant is <<[1] Yes, I have been hired for this job>>, the Call-back is ended, the acceptation is validated by the system and the <<Acceptation>> field is turned to <<Yes>> in the table “Application” 68. In case of confirmation—call or mail to the Recruiter—, the application field <<Acceptation>> field turns to <<YesConfirmed>>, the <<Status>> one to <<Hired>>. An invoice may be sent to the recruiter. Statistics are made on the winning viral chain, and the nodes are rewarded.

On step 210b, if the answer of the applicant is <<[2] No, I have not been hired for this job>>, the call back is ended by the system. validation is made by the system: in the table “Application” 68, the application field <<Status>> turns to <<NotHired>>, the <<Acceptation>> one turns to <<No>>. In case of confirmation, the application field <<Acceptation>> turns to <<NoConfirmed>>, the <<Status>> one to <<NotHired>>, and nothing is triggered.

On step 210c, if the answer of the applicant is <<[3] I have received no news from the Recruiter yet>>, or if the applicant has not answered at all, the application field <<Acceptation>> remains at <<Run>> in the table 68. The system looks, on step 220, whether the time between the date of the day and the date of the application is equal to three month. If the answer is “no”, the system does not send a second call-back mail. If the answer is “yes”, the system goes back to the step 180.

From the previous description, several advantages become apparent.

Thanks to the traceability, allowed by the linearization of the reverse propagation, we are able to answer the questions: does the search expressed by the originator was fitted? Did the originator find a better answer to the search with someone else? Did the originator finally get satisfaction through the application? If yes, how long did it last? And how many answers did the originator get?

All these information enable the originator to value at the same time the clarity of demand, the relevancy of network, the plurality and the quality of all members, and finally the performance of the application.

We provide dynamic means for improvement of the relevance of the system by the system itself:
by calculation of statistics during the feedback on the winning viral chain;
by rating of the members' quality.

The power of the technology of meshing and traceability of the system allows a self-improvement by the system itself and allows to show in a very simple way the promise of efficiency of the system. Every originator finds detailed statistics about each member, concerning efficiency as a head-hunter: number of propagation chains to which the originator has belonged, percentage of chains having generated an application—in the sense of answer to the expressed search—or having been retained by the originator—in the sense of better obtained answer, and is able to appreciate the strike force of the broadcasting by co-option of offers: total number of members informed of the offer, and detail by level of node.

The system improves the “filter by the human being” in every stage of the propagation by inserting statistical results, for example, at each incrementation level of the network tree propagations.

The first nodes of propagation chains are selected by the originator among acquaintances eventually completed by relevant members profiled in the database; the following nodes are the objects of an electronic co-option by their antecedent in the chain. It means that the following nodes can be trustworthy relevant people who can not be member yet of the database, but who are requested by their node before in order to satisfy the search, or to put it through the right person in their network.

Thus, the relevance extends beyond the only community of the members registered in the database, and the broadcasting continues with a double creed: the human filtering, the electronic traceability. The involvement of the entities in the propagation of the search, associated with this electronic history of each of their actions and the resulting effects, also serves to feed statistical analysis of the qualification of members, in order to optimize future propagations.

The system does not require a minimum number of members.

The system allows a systematization of the co-option: by definition, the classical co-option stops to the network of nearness. The system of the invention allows going beyond the first curtain of its network: as a supplement to the originator's own knowledge, the originator can select among the members of the database those susceptible to be relevant first nodes of viral chain. In the classic co-option, the relevance is limited to 2 levels. Even there, the recruiter will benefit from a pledge at every level of the chain, thanks to the principle of recommendation.

The promise to be rewarded if one is in a winning viral chain enhances it to be efficient during the progress of a search.

Because its network of acquaintances is not so extensive, one understand the interest to belong to the profile database in order to increase the chances to be selected as a node during the generation of a network of contacts in function of a given search, even if one is not seeking for a job. It finds an interest to keep on receiving offers corresponding to its profile, to become head-hunter.

The incentives boost the constitution of a wide and deep base of profiled candidates/head-hunters: to be in the beginning of a chain, it is the guarantee not to miss opportunities for oneself: candidate, or for somebody in its network: head-hunter. Besides, in case of hiring, the fact to reward more the first node and the last one before the applicant, values those who distribute offers in a relevant way, contrary to a die-hard distribution.

Thanks to the uniqueness of receipt, the system avoids polluting the members, and allows a unique traceability in case of winning viral chain, encourages members to broadcast quickly, and calculates efficient statistics, without duplication, for example on the dynamic generation of a network of contacts, on the network tree propagations, and/or on the effectiveness of each entity.

As for any mission of hunting, it is necessary to make sure if there was hiring of one of the candidates presented to the recruiter, this to be able to charge the balance of the mission. The system allows automating this function of confirmation of the acceptation, thanks to both the traceability allowed by the tool and the incentive policy.

As said before, two thirds of the vacancies are provided through the personal or professional network; most of these are never published and are a part of the “hidden market”. The first reflex of a recruiter is to ask around, to activate its professional and personal network.

Beyond the ease, beyond the speed, and beyond the moderate cost bound to the use of the network, one of the advantages of the co-option in the field of the recruitment is the rate of success of the employees, once engaged. Indeed, the recruitment through the network supposes a reliable relation: “co-opting” someone engage one's responsibility and credibility, the “co-opted” is grateful to the one who co-opted, and the employer obtains a widened guarantee because the candidate is recommended by a trusted contact. The natural continuation of the search by the network is the normalization of the process of co-option in the company, by introducing a payment of the intermediary entities that participate in the recruitment.

The system is an alternative to Internet job boards: the advantages of a solution of e-recruitment, the advantages of the relevance.

The system has been described in the recruitment domain, but is not restricted to this domain. The system is relevant in general: searches for identification of a set of a population to satisfy a need, in other words, the sourcing, in more specific domains:
Apartment search,
The search for buyers by a real-estate salesman (real estate agency, particular salesman, real-estate hunter) in the field of the real-estate,
The search for real estates (for a company or a private individual) to buy or to rent by a company or a private individual, in the field of the real-estate,
The search for value-added information or skills, in the field of the scientific research namely.

The system is also relevant in other applications such as sponsoring programs of new customers who allow rewarding the filiations when a membership occurs beyond the 2nd node (possibility of defining a specific reward to each of the nodes of the chain that resulted to the membership, according to their location in the aforementioned chain).

Other aspects are conceivable.

More than a simple text of recommendation, the member who co-opted the applicant could emit a detailed recommendation, including specific fields as:
Nature of link: Personal/Professional;
Information on possible gathered working experience;
Information on possible hierarchical links.

The member who co-opted the applicant could even emit a graded recommendation, concerning different features as:
Degree of global knowledge: Grades from 1 to 5;
Degree of professional knowledge: Grades from 1 to 5;
Degree of confidence: Grades from 1 to 5;
And so on, e.g.: commitment, rigor, creativity, office automation skills, master's degree of the foreign languages, international work experience.

More than just a list of grades, the originator could specify a minimum level required for each of the criteria, hidden from the member who co-opted the applicant.

Instead of a standard list of features, the originator could customize a grid of skills, according to the need to cater for.

The system may consider that one recommendation is linked to one application. However, the system can also consider that recommendations are connected to the buzzer, so that an originator can read all previous recommendations emitted after all applications the buzzer has already posted.

The system can request a recommendation to the member who co-opted the applicant, but also to the applicant, on the same criteria. Hence the originator could compare both of it, and conclude about their coherence and so their relevancy, or about the capacity of auto-analysis of the applicant, for example.

If the first node of the winning viral chain is an internal first node—an employee of the company that posted the offer—, the system can invite the first node to emit an additional recommendation on the applicant. After getting in touch with the applicant by e-mail, the first node can, for instance, meet or have a phone conversation to endorse an application before this latter arrives on the virtual desktop of the originator.

Each member of the winning viral chain can be requested to emit a recommendation about the one co-opted (recommendation at each step of the distribution):
the system would send an e-mail to all previous nodes of the chain, as soon as the application is sent;
another variant could include asking a recommendation for any buzzer down specified by a buzzer, whatever the issue of the generated viral chains, and whatever the offer concerned.

The originator can grade members of the system database, but also each first node that is connected to the originator: table “List of first nodes” 78, including the originator's internal one.

The originator can even distinguish the members and the way to grade them according to their distinct roles within the community, for instance: the first buzzing, the hunting, the recommending and the applying accuracy of each of them.

The system solution could propose to the originator to gather such notation with all other originators, or to keep it confidential.

To help the originator in searching for additional first nodes within the profile database 60—the first buzzers—, the profiling members can include a field that defines their main role among the community. A member may self-qualify as e.g. a head-hunter, an active seeker, or a passive seeker.

Many more fields can be implemented to deepen the member profile, for a better preselection by the originator. For example: office automation skills, spoken foreign languages, level of studies, wage claims, marital situation, degree of availability, possibility of relocation, working visa for such or such country.

The system considers that the originator is the most relevant person to define the first nodes of the viral chains, because the originator is the only one to know precisely the expectations.

However, the selection of first nodes can also be assumed by the system. The originator explains to the system the need to cater for, and the system can traduce it in terms of buzzer profiling, maybe would even write the offer, and would select the first nodes before launching the distribution of it.

Thanks to the statistics, and in function of the search, the system can calculates, at each level, the most efficient number of entities that can be contacted: for example at level “1”: 15, at level “2”: 10, at level “3”: 8, at level “4”: 5, at the following level “n”: 3.

The system can also calculate the most efficient number of level for the progress of a given search depending on one or more factor.

1-13. (canceled)

14. An open system for dynamically generating a network of contacts, wherein the network is implemented as levels in a tree that is propagated incrementally as a function of each given search from a user of a level “zero” to one or more final entities or “leaves” unknown to the user and satisfying search criteria, propagation taking place via entities of a level “1” forming a first network of acquaintances that are known directly and/or indirectly to the user, and via one or more intermediary entities of levels “n”, unknown to the user and each having a respective network of acquaintances formed by contacts with entities of levels “n+1”, the system including a filter which is run at each incremental level by removing duplication of contacts with entities so that each entity of level “n+1” in the chain refers to a unique entity of level “n” forming a linear reverse propagation.

15. The system according to claim 14, wherein the filter comprises means that act on each search to prevent duplicated contacts between the networks of acquaintances of the entities.

16. The system according to claim 15, wherein the system includes:
a database concerning history of progress of the search and comprising contact information of entities that have already been contacted in the progress of the search,
means for compiling the database as the search progresses from an entity towards its network of acquaintances, and
means for activating or not activating entity contact information of entities in a network of acquaintances as the search progresses to a higher level, depending on whether the entity contact information is absent from or present in contact information of entities that have already been contacted as the search progresses.

17. The system according to claim 14, wherein the system further comprises:
a statistics database concerning the effectiveness of each entity,
means for compiling the statistics database with respect to the search, and
means for selecting an entity depending on its effectiveness.

18. The system according to claim 17, wherein the effectiveness of a given entity is represented by a criterion selected from the group consisting of relevance of entities that the given entity has contacted in the course of successful searches previously undertaken in system, sphere of activity of the given entity, job type of the given entity, number of different entities previously contacted by the given entity, and a combination of these criteria.

19. The system according to claim 14, further comprising traceability means for constituting a search history comprising each of the actions of the entities, and the effects generated by the actions.

20. The system according to claim 14, further comprising identification means for identifying each entity level in each linear search progress chain.

21. The system according to claim 14, wherein, on each incrementation of level, the filter removes any interconnection between any of the search progress chains by comparing statistical data concerning the entities with at least one criterion.

22. The system according to claim 21, wherein said criterion is selected from the group consisting of: the selection chronology of the level n entity, the respective effectiveness of the entities that have selected the level n entity, and the levels of the entities that have selected the level n entity.

23. The system according to claim 14, further comprising progress-limiting means for limiting at each level the progress of the search in compliance with a degree of confidentiality given by the user or by the system itself.

24. The system according to claim 14, further comprising remuneration means for remunerating the entities as a function of their effectiveness and/or of their goals to the success of the search.

25. The system according to claim 24, wherein the remuneration is selected from the group consisting of pecuniary remuneration, payment in kind, payment in points and payment in advantages.

26. The system according to claim 14, further comprising means for traceability of the search history and generating automatic call-back to register relevance and success of the answer given by the entities.
